(19) United States
(12) Patent Application Publication
(10) Pub. No.: US 2009/0145835 A1
(43) Pub. Date: Jun. 11, 2009

(54) WATER TREATMENT CONTACT FILTER AND WATER TREATMENT APPARATUS

(75) Inventors: Takane KITAO, Kyoto (JP); Kazuhiro ONUMA, Ehime (JP); Hiroshi MATSUMURA, Aichi (JP)

Correspondence Address: DENNIS G. LAPOINTE;LAPOINTE LAW GROUP, PL, PO BOX 1294, TARPON SPRINGS, FL, 34688-1294, US

(73) Assignee: ECO WORK CO., LTD., Tokyo (JP)

(21) Appl. No.: 12/047,338

(22) Filed: Mar. 13, 2008

(30) Foreign Application Priority Data
Dec. 5, 2007 (JP) 2007-314182

(51) Int. Cl. B01D 29/07

(52) U.S. Cl. 210/336; 210/496; 210/335

(57) ABSTRACT

This invention provides a fiber filter and a sewage purifier capable of realizing effective use of the capacity of a treatment tank and being easily manufactured. A fiber filter is formed in a manner that ends of a plurality of fibrous materials made of carbon fibers bundled into a fiber bundle are connected to each other at a fixation part. The fiber filter is used as a filter of an anaerobic filter-bed tank of a sewage purifier. A part, which is not fixed at the fixation part, of the fibrous materials of the fiber filter spreads and develops in a tuft shape in sewage. Thus, the surface area of the fiber filter can be increased. Capacity necessary for treatment of the sewage W can be reduced and effectively used. The fiber filter can be easily manufactured due to its simple constitution.

### RELATED APPLICATION

The present application claims priority under 35 U.S.C. §119 to Japanese Patent Application No. 2007-314182 filed on Dec. 5, 2007. The content of the application is incorporated herein by reference in its entirety.

### FIELD OF THE INVENTION

The present invention relates to a water treatment contact filter having a plurality of fibrous materials and a water treatment apparatus provided with the filter.

### BACKGROUND OF THE INVENTION

Conventionally, this type of water treatment apparatus has an anaerobic filter-bed tank used in a primary treatment part of a sewage purifier. It is known that, in the anaerobic filter-bed tank, the middle part of a treatment tank in a vertical direction is filled with anaerobic filters, and sewage vertically flows through the anaerobic filters (see Patent document 1: Japanese Laid-Open Patent Publication No. 2003-334591).

As described above, in an anaerobic filter-bed tank, foreign matter contained in sewage flowing into the anaerobic filter-bed tank form into sludge to be deposited on the bottom of a treatment tank. When the sludge is further deposited on the bottom of the treatment tank, anaerobic filters in the treatment tank are blocked, the sewage can hardly pass through the anaerobic filters, the level of sewage in the treatment tank rises, and this may result in overflow of the sewage. When the sludge is furthermore deposited on the bottom of the treatment tank, there is a possibility that the sewage flows out from the treatment tank.

Thus, in the anaerobic filter-bed tank, large amounts of sludge cannot be easily deposited in the treatment tank, the sludge can be stored in only a part of the treatment tank capacity, and the capacity of a portion, in which the sludge cannot be deposited, of the treatment tank capacity is increased.

Additionally, in the anaerobic filter-bed tank, when the sludge deposited in the treatment tank is discharged outward from the treatment tank, the sludge is required to be drawn out from the bottom of the treatment tank, and a cleaning hole penetrating to the bottom of the treatment tank is required to be provided so that a hose for drawing-out sludge can be inserted to the bottom of the treatment tank. Further, a pressing member is required as a receiving member of the anaerobic filters so that the middle part of the treatment tank in a vertical direction is filled with the anaerobic filters.

As described above, in the anaerobic filter-bed tank, the capacity of the treatment tank cannot be effectively used, a filling method of the filter members and the inner structure of the treatment tank having the cleaning hole are complicated. Thus, the anaerobic filter-bed tank cannot be easily manufactured.

The present invention has been made in view of the above problems, and has an object of providing a water treatment contact filter capable of realizing effective use of the capacity of the treatment tank and being easily manufactured, and a water treatment apparatus provided with the water treatment contact filter.

### SUMMARY OF THE INVENTION

A water treatment contact filter according to a first aspect of the invention includes a fiber bundle having a plurality of fibrous materials and in which a plurality of fibrous materials are bundled, and a fixation part for fixing at least a part of the fiber bundles.

A water treatment apparatus according to a second aspect of the invention includes a treatment tank in which the water treatment contact filter according to the first aspect of the invention is arranged and water to be treated is stored, and straightening means for horizontally straightening the flow of the water to be treated in the treatment tank.

In the water treatment apparatus according to the second aspect of the invention, a water treatment apparatus according to a third aspect of the invention includes a plurality of water treatment contact filters and the plurality of water treatment contact filters are arranged zigzag in a plan view.

In the water treatment apparatus according to the second or third aspect of the invention, a water treatment apparatus according to a fourth aspect of the invention includes a plurality of water treatment contact filters and the plurality of water treatment contact filters are vertically aligned.

According to a water treatment contact filter according to the first aspect of the invention, since at least a part of a fiber bundle, in which a plurality of fibrous materials are bundled, is fixed to a fixation part, a part, which is not fixed at the fixation part, of these fibrous materials spreads in water to be treated, the surface area of each fibrous material is increased, and thus capacity necessary for treatment of water to be treated can be effectively used. Additionally, since the contact filter is simple in structure, it can be easily manufactured.

According to a water treatment apparatus of the second aspect of the invention, since the flow of the water to be treated in a treatment tank is horizontally straightened by straightening means, the part, which is not fixed at the fixation part, of the plurality of fibrous materials of the water treatment contact filters according to the first aspect of the invention provided in the treatment tank spreads in the water to be treated, the water to be treated can be efficiently treated by these water treatment contact filters, a great amount of sludge generated from the water to be treated can be deposited on the bottom of the treatment tank, and thus the capacity of the treatment tank can be effectively used.

According to a water treatment apparatus of the third aspect of the invention, in addition to the effect of the water treatment apparatus of the second aspect of the invention, since the plurality of water treatment contact filters are arranged zigzag in a plan view and thus can be efficiently arranged in the treatment tank, treatment efficiency of the water to be treated in the treatment tank by these water treatment contact filters can be further raised.

According to a water treatment apparatus of the fourth aspect of the invention, in addition to the effect of the water treatment apparatus of the second or third aspect of the invention, since the plurality of water treatment contact filters are vertically aligned and thus more water treatment contact filters can be efficiently arranged in the treatment tank, the treatment efficiency of the water to be treated in the treatment tank by these water treatment contact filters can be further raised.

### BRIEF DESCRIPTION OF THE DRAWINGS

FIG. 1 is an explanatory cross sectional view showing a water treatment apparatus of an embodiment of the present invention;

FIG. 2 is an explanatory plan view showing the water treatment apparatus;

FIG. 3 is a cross sectional view taken along line a-a in FIG. 2; and

FIG. 4 is a cross sectional view taken along line b-b in FIG. 2.

### DETAILED DESCRIPTION OF THE PREFERRED EMBODIMENT

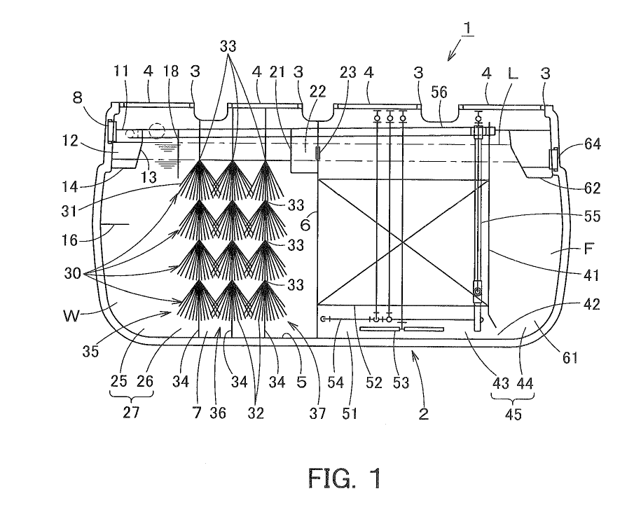

An embodiment of the water treatment apparatus of the present invention will be described below with reference to FIG. 1 to FIG. 4.

In FIG. 1 to FIG. 4, the reference numeral 1 denotes a sewage purifier as a water treatment apparatus. The sewage purifier 1 includes a tank body 2 as a treatment tank for storing sewage W as flow-in water to be treated. The tank body 2 is formed in an approximate rectangular shape in a plan view. A plurality of, for example, four openings 3 are arranged at the vertically upper part of the tank body 2 in a longitudinal direction of the tank body 2. A cover 4 is detachably attached to each opening 3. Additionally, a bottom 5 positioned at the vertically lower part of the tank body 2 is formed in an approximate flat shape.

Further, a first partitioning plate 6 is attached to the middle part of the tank body 2 in the longitudinal direction, and the middle part of the tank body 2 in the longitudinal direction is partitioned by the first partitioning plate 6, in a width direction and a vertical direction. An upstream side region, which is one end side in the longitudinal direction of the inside of the tank body 2 being partitioned by the first partitioning plate 6, is used as an anaerobic filter-bed tank 7 which is an anaerobic treatment tank.

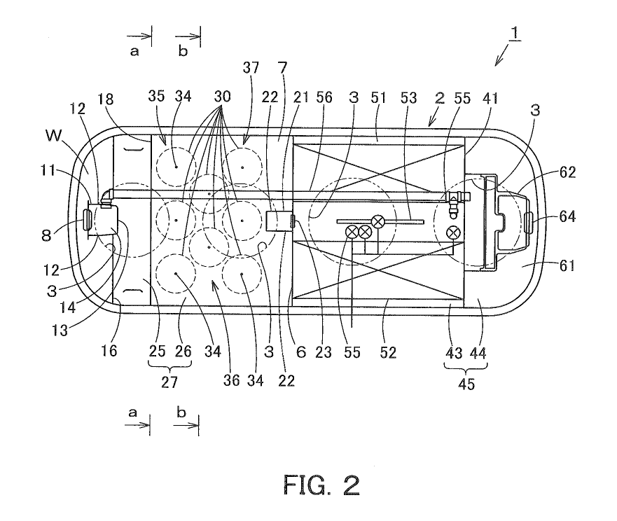

Concretely, the anaerobic filter-bed tank 7 includes a flow-in port 8 provided at the middle part of the upstream side of the tank body 2 in the width direction. The flow-in port 8 is provided at the vertically upper side of the tank body 2, and the sewage W flows into the anaerobic filter-bed tank 7 of tank body 2 through the flow-in port 8. A flow-in baffle 11 as buffering means for buffering a flow of the sewage W flowing in through the flow-in port 8 is attached to a position opposite the flow-in port 8 inside the tank body 2. As shown in FIG. 2, the flow-in baffle 11 is vertically penetrated and is formed in an approximate U-shape in the plan view.

A pair of flat both side edges 12 positioned at both sides of the flow-in baffle 11 in the width direction is attached to a position on the outside in the width direction from an edge of the flow-in port 8 in an inner surface of the tank body 2. Additionally, the flow-in baffle 11 is attached in a state that an upper end edge of the flow-in baffle 11 is positioned lower than an upper end edge of the flow-in port 8 in the vertical direction. Further, an approximately flat middle piece 13 is provided between the pair of the side edges 12 of the flow-in baffle 11, and is formed downward obliquely toward the upstream side of the tank body 2.

Additionally, a flow-out port 14, through which the sewage W flowing in from the flow-in port 8 flows out to the lower side, is provided at the lower side of the flow-in baffle 11. The flow-out port 14 is opened downward. A flat straightening baffle 16 as straightening means is attached to a position opposite the flow-out port 14 of the flow-in baffle 11. The straightening baffle 16 horizontally, laterally, straightens the flow of the sewage W flowing out of the flow-out port 14 of the flow-in baffle 11. Concretely, the straightening baffle 16 is formed in a flat shape, a side edge of the straightening baffle 16 is connected and attached to the inner surface of the tank body 2 with an end surface of the straightening baffle 16 opposed in parallel with the flow-out port 14 of the flow-in baffle 11. Further, the straightening baffle 16 is horizontally attached to the middle part of the inner surface at the upstream side of the tank body 2 in the vertical direction.

A scum baffle 18 as scum preventing means for preventing scum (not shown) generated on a liquid surface L of the sewage W from flowing is attached to a position opposite the middle piece 13 of the flow-in baffle 11 in the tank body 2. The scum baffle 18 prevents the scum from flowing toward the downstream side of the tank body 2, the scum being generated in a manner that small floating sludge having a specific gravity smaller than that of oil and fat or water contained in the sewage W flowing in from the flow-in port 8 is deposited on the liquid surface L of the sewage W.

Concretely, the scum baffle 18 is formed in an elongated flat-plate shape, both side edges of the scum baffle 18 in a longitudinal direction are connected to both side edges in the tank body 2 in the width direction with a width direction of the scum baffle 18 laid in the vertical direction. Further, the scum baffle 18 is attached in a state that an upper end edge of the scum baffle 18 in a width direction, the vertical direction, is laid along the upper end edge of the flow-in baffle 11. Additionally, the scum baffle 18 is attached in a state that a lower end edge of the scum baffle 18 in the vertical direction is projected slightly lower than the flow-out port 14 of the flow-in baffle 11, and a part lower than the lower end edge of the scum baffle 18 of the inside of the tank body 2 communicates in the longitudinal direction.

Further, a transferring baffle 21 as transferring means is attached to the upstream side of the first partitioning plate 6 of the tank body 2. The transferring baffle 21 makes the sewage W anaerobically treated in the anaerobic filter-bed tank 7 flow out from the anaerobic tank 7 to transfer it. Concretely, the transferring baffle 21 is vertically penetrated and formed in an approximate U-shape in the plan view. The transferring baffle 21 is attached by connecting a pair of flat side edges 22, which is positioned at both sides of the transferring baffle 21 in a width direction, to a side surface at the upstream side of the first partitioning plate 6. Additionally, the transferring baffle 21 is attached in a state that an upper end edge of the transferring baffle 21 is horizontally laid along the upper end edge of the scum baffle 18. Further, a lower end edge of the transferring baffle 21 is provided so as to be horizontally laid along the lower end edge of the scum baffle 18.

A transfer port 23 is opened and disposed at a position opposite the transferring baffle 21 of the first partitioning plate 6. The sewage W, which is anaerobically treated in the anaerobic filter-bed tank 7 and flows in from the lower end side of the transferring baffle 21, is made to flow out to the downstream side of the first partitioning plate 6 and transferred through the transfer port 23. Concretely, the transfer port 23 is formed in a circle or rectangular shape smaller than the width between both the side edges 22 of the transferring baffle 21 and provided so as to penetrate through the first partitioning plate 6.

Here, a region at the upstream side from the scum baffle 18, in the plan view, of the inside of the tank body 2 is a straightening region 25 for evenly laterally straightening the flow of the sewage W flowing in from the flow-in port 8. That is, the straightening region 25 is positioned at the upstream side from the scum baffle 18, in the plan view, in the anaerobic filter-bed tank 7, and is a part for separating foreign matter from the sewage W before the sewage flowing into the anaerobic filter-bed tank 7. On the other hand, a region from the scum baffle 18 to the first partitioning plate 6, in the plan view, of the inside of the tank body 2 is an anaerobic treatment region 26 where the sewage W straightened in the straightening region 25 is subjected to the anaerobic treatment. The anaerobic treatment region 26 is a part from the scum baffle 18 to the first partitioning plate 6, concretely, to the transferring baffle 21, in the plan view, of the inside of the anaerobic filter-bed tank 7. Moreover, a region on the upstream side of the first partitioning plate 6 of the tank body 2 is a primary treating part 27, the region including the straightening region and the anaerobic treatment region 26.

Further, a plurality of fiber filters 30, which are anaerobic filters as water treatment contact filters, are disposed between the scum baffle 18 and the transferring baffle 21 in the anaerobic treatment region 26. Each fiber filter is constituted by a bundled fiber bundle 31, and the fiber bundle 31 is formed of a plurality of fibrous materials 32 made of carbon fibers having a width of, for example, 0.7 μm. Thus, with each fibrous material made of carbon fiber, the fiber filter 30 has a function of absorbing toxic substances and pollutants in the sewage W. Concretely, the fiber filter 30 is a tuft-shaped fiber filter constituted in a manner that the plurality of fibrous materials 32 are arranged in a longitudinal direction and bundled into the fiber bundle 31, ends of the fibrous materials 32 of the fiber bundle 31 in the longitudinal direction are connected and fixed to each other to form into a fixation part 33, and the other ends of the fibrous materials 32 of the fiber bundle 31 in the longitudinal direction are not connected to each other and each is constituted as a free end.

Here, with the fiber filters 30, anaerobic microbes are made to adhere to respective fibrous materials 32 of the fiber filters 30 and to biodegrade organic matter and sludge in the sewage W and perform the anaerobic treatment, and the pollutants in the sewage W is held, as sludge, by the respective filters 32 of these fiber filters 30. Further, these fiber filters 30 are provided in the anaerobic filter-bed tank 7 so that the total of the surface areas of the fibrous materials 32 of the fiber filters 30 to the capacity of the anaerobic filter-bed tank 7 is, for example, 10 m²/m³ to 40 m²/m³.

The fiber filters 30 are attached to a plurality of chain-shaped or rod-shaped attachment member 34 vertically arranged in the tank body 2. Concretely, the fiber filters 30 are vertically aligned at even intervals and attached to the attachment member 34 with the fixation part 33 sides of the plural, for example, four fiber filters 30 directed upward. The fiber filters 30 are attached to the attachment member 34 in a manner that each fixation part 33 of the fiber filters 30 is fixed to the attachment member 34. Further, the attachment members 34 are attached in a state that the fiber filters 30 are separated from each other at even intervals in a longitudinal, vertical, direction of the attachment member 34. Concretely, a fixation part 33 of a fiber filter 30 is fixed at a position slightly lower than a lower end edge of another fiber filter 30 disposed adjacently above the former fiber filter 30.

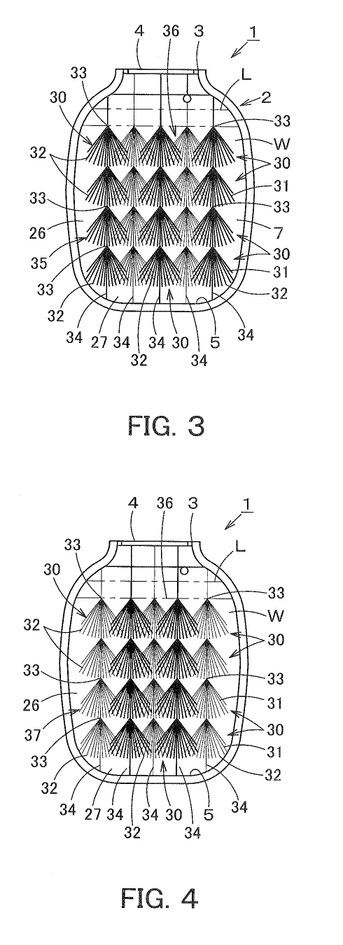

Here, for example, the eight attachment members 34 are arranged in the tank body 2, upper ends of the attachment members 34 are connected to the tank body 2, and the attachment members 34 are vertically attached in the tank body 2. Additionally, as shown in FIG. 2 and FIG. 3, the three attachment members out of these attachment members 34 are attached at a position close to the scum baffle 18 of the tank body 2 so as to be aligned at even intervals in the width direction of the tank body 2, and attached as a first line 35. Concretely, the attachment member 34 positioned at the center of the attachment members 34 attached to the first line 35 is attached to the center of the tank body 2 in the width direction. Additionally, both the side attachment members 34 attached to the first line 35 are attached to positions respectively separated from each other at even intervals from the center of the tank body 2 in the width direction.

Further, the two attachment members 34 other than the attachment members 34 attached to the first line 35 are aligned at the downstream side, relative to the attachment members 34 on the first line 35, of the tank body 2 and in the width direction of the tank body 2, and attached as a second line 36. Concretely, as shown in FIG. 2 and FIG. 4, the attachment members 34 attached to the second line 36 are attached at positions respectively, the positions being separated from each other at even intervals from the center of the tank body 2 in the width direction, and being between the center attachment member 34 and both the side attachment members 34 on the first line 35 in the longitudinal direction of the tank body 2. Additionally, the three attachment members 34 other than the attachment members 34 attached to the first and second lines 35, 36 are attached to a position close to the transferring baffle 21 of the tank body 2 so as to be aligned at even intervals in the width direction of the tank body 2, and attached as a third line 37. The attachment members 34 are attached to the third line 37 at an interval the same as that of the attachment members 34 attached to the first line 35.

Additionally, the attachment members 34 attached to the first, second and third lines 35, 36 and 37 are arranged at even intervals, and the fiber filters 30 attached to the attachment members 34 of the first, second and third lines 35, 36 and 37 are separated from each other so as not to be in contact with each other. Accordingly, as shown in FIG. 2, the attachment members 34 attached to the first, second and third lines 35, 36 and 37 are arranged zigzag, in a plan view, between the scum baffle 18 and transferring baffle 21 in the tank body 2. Further, the fiber filters 30 attached to the attachment members 34 are also arranged zigzag in the plan view, and in a plane shape with one of the other attachment members 34 interposed between a pair of the attachment members 34.

Accordingly, the fiber filters 30 are arranged in the plane shape in the vertical, longitudinal, and lateral directions of the anaerobic filter-bed tank 7 in the tank body 2. Additionally, the fibrous materials 32 of the fiber filters 30 spread in a tuft shape from the fixation part 33 with the sewage W flowing in the anaerobic filter-bed tank 7 in the tank body 2, and thus the fiber filter 30 has a function of horizontally transferring the sewage W in the anaerobic filter-bed tank 7 from the upstream side to the downstream side while laterally straightening the flow of the sewage W.

On the other hand, a second partitioning plate 41 having an opened lower end is attached between the first partitioning plate 6 of the tank body 2 and the inner surface at the downstream side of the tank body 2. The second partitioning plate 41 is formed in a plate shape, and attached in the tank body 2 at a longitudinal direction of the plate 41 laid along the vertical direction. Additionally, both side edges of the second partitioning plate 41 in a width direction are connected to the inner surface of the tank body 2 in the width direction. Further, the second partitioning plate 41 is attached in a state that an upper end edge of the second partitioning plate 41 is horizontally laid along an upper end edge of the first partitioning plate 6. Additionally, a predetermined interval is provided between a lower end edge of the second partitioning plate 41 and the bottom 5 of the tank body 2 so as to form a flow-out port 42. Furthermore, the lower end edge of the second partitioning plate 41 is obliquely formed toward the inner surface side positioned at the downstream side of the tank body 2.

Here, a region of the inside of the tank body 2 from the first partitioning plate 6 to second partitioning plate 41 is an aerobic treatment region 43 as a contact aeration region for subjecting the sewage W flowing out from the anaerobic filter-bed tank 7 to aerobic treatment. The aerobic treatment region 43 is a portion provided on the downstream side of the anaerobic treatment region 26, and subjects the sewage anaerobically treated in the anaerobic treatment region 26 to the aerobic treatment. Further, a region of the inside of the tank body 2 lower than the second partitioning plate 41 is a precipitation region 44 into which the sewage W aerobically treated in the aerobic treatment region 43 flows. The precipitation region 44 is provided on the downstream side of the aerobic treatment region 43, and sludge contained in the sewage W aerobically treated in the aerobic treatment region 43 is precipitated. Further, a region on the downstream side of the first partitioning plate 6 of the tank body 2 including the aerobic treatment region 43 and the precipitation region 44 is a secondary treating part 45.

A contact aeration tank 51 as an aerobic treatment tank is provided between the first partitioning plate 6 and second partitioning plate 41 of the tank body 2, the region from the first to second partitioning plates being the aerobic treatment region 43. Further, a filter filled layer 52 filled with aerobic filters (not shown), which are contact filters, is provided at the middle part of the contact aeration tank 51 in the vertical direction. The filter filled layer 52 is provided in a manner that the part between the first partitioning plate 6 and second partitioning plate 41 in the tank body 2 is vertically partitioned. The sewage W flowing into the contact aeration tank 51 from the transfer port 23 of the first partitioning plate 6 is made to pass from upward to downward while being mixed and agitated. Then, the aerobic microbes adhered to the aerobic filters filled into the filter filled layer 52, biodegrades the organic matter and sludge in the sewage W passing through the filter filled layer 52 and subjects the sewage to the aerobic treatment. Further, a gas diffuser 53 as aerating means for aerating the sewage W flowing into the contact aeration tank 52 is attached to the contact aeration tank 52. The gas diffuser 53 diffuses gas such as air containing oxygen, etc., into and aerates the sewage W flowing into the contact aeration tank 7 by, for example, feeding the gas to the bottom 5 of the contact aeration tank 51, concretely, to a part lower than the filter filled layer 52.

Further, a backwash unit 54 for washing the aerobic filters filled into the filter filled layer 52 is attached under the filter filled layer 52 of the contact aeration tank 51. The backwash unit 54 strongly diffuses gas such as air compared with aeration of the gas diffuser 53 from the part lower than the filter filled layer 52, makes the sewage W flow upward from downward through the filter filled layer 52, and washes away the sludge adhered to the aerobic filters filled into the filter filled layer 52.

Additionally, a returning unit 55 as sewage returning means for transferring and returning the sewage W in the contact aeration tank 51 into the anaerobic filter-bed tank 7 is attached to the contact aeration tank 51. The returning unit 55 includes a sludge transfer pipe 56 which is an elongated cylindrical pipe body, and is disposed with the upstream side of the sludge transfer pipe 56 inserted in the bottom 5 of the upstream side of the contact aeration tank 51. Further, the downstream side of the sludge transfer pipe 56 is attached to and made to penetrate through a side edge 12 of the flow-in baffle 11 of the anaerobic filter-bed tank 7, and the sludge transfer pipe 56 is attached in a state of being inserted in the flow-in baffle 11. Additionally, the sludge transfer pipe 56 is disposed in a state that the middle part of the pipe 56 is made parallel with the liquid surface L of the sewage W stored in the tank body 2. Further, the sludge transfer pipe 56 can transfer and discharge the sludge precipitated and deposited on the bottom 5 of the contact aeration tank 51 outward from the tank body 2. Moreover, the sludge transfer pipe 56 may be provided in a precipitation tank 61.

On the other hand, the precipitation tank 61 as precipitating means is provided on the downstream side of the second partitioning plate 41 in the tank body 2. The inside of the precipitation tank 61 is the precipitation region 44, and sludge such as foreign matter contained in the sewage W, which is subjected to the aerobic treatment in the contact aeration tank 51 and flows in from the flow-out port 42 on the lower end side of the second partitioning plate 41, is precipitated in the precipitation tank 61 and deposited on the bottom 5 of the precipitation tank 61. Further, an overflow baffle 62 as overflowing means, for making treated water F obtained by removing the sludge, etc., from the sewage W in the precipitation tank 61 overflow, is attached to the upper side of the precipitation tank 61. The overflow baffle 62 has a closed bottom, is formed in an approximate U-shape in the plan view, and connected and attached to the inner surface at the downstream side of the tank body 2 with an opened part of the overflow baffle 62 directed upward and toward the downstream side of the tank body 2.

A flow-out port 64, through which the treated water F overflowing the overflow baffle 62 flows outward from the tank body 2, is opened at a position, opposite the overflow baffle 62, on the inner surface at the downstream side of the tank body 2. The flow-out port 64 is positioned oppositely to the flow-in port 8 provided at the upstream side of the tank body 2, and provided at a position eccentric vertically downward compared with the flow-in port 8.

Next, a water treating method using the water treatment apparatus of the embodiment will be described.

First, the sewage W flowing in from the flow-in port 8 of the tank body 2 of the sewage purifier 1 flows into the flow-in baffle 11 from the flow-in port 8 of the tank body 2, the flow of the sewage W is weakened by the flow-in baffle 11, and the sewage W flows downward from the flow-out port 14 of the flow-in baffle 11.

Then, the sewage W flows downward in the straightening region 25 in the tank body 2, and the flow of the sewage W is laterally straightened by the straightening baffle 16 provided in the straightening region 25. Here, in the straightening region 25, the scum baffle 18 prevents scum from flowing to the anaerobic treatment region 26 at the downstream side, the scum being generated on the liquid surface L of the sewage W by the small floating sludge having a specific gravity smaller than that of oil and fat or water contained in the sewage W.

The sewage W further laterally flows to the anaerobic treatment region 26 from the straightening region 25 and comes into contact with the anaerobic microbes adhered to the fibrous materials 32 forming each fiber filter 30 of the anaerobic treatment region 26, and the pollutants in the sewage W are, as sludge, held by, deposited on and buried in the fibrous materials 32 of each fiber filter 30 while the organic matter and sludge in the sewage W are anaerobically biodegraded by the anaerobic microbes. Additionally, the sludge deposited on the fibrous materials 32 of the fiber filters 30 are anaerobically biodegraded by many anaerobic microbes adhered to the fibrous materials 32.

At this time, the fibrous materials 32 of each fiber filter 30 spread and develop in a tuft shape from the fixation part 33 by the flow of the sewage W. Thus, with the fibrous materials 32 of each fiber filter 30 spreading in a tuft shape from the fixation part 33, the flow of the sewage W is evenly laterally straightened.

Additionally, the sludge held by the fibrous materials 32 of the fiber filter 30 grows with passage of the sewage W. When the amount of the sludge held by the fibrous materials 32 reaches a certain degree, the sludge is peeled off, as a clump, from the fibrous materials 32, and precipitated and deposited on the bottom 5 of the anaerobic filter-bed tank 7 by the flow of the sewage W.

Further, the sewage W anaerobically treated in the fiber filters 30 flows upward along the first partitioning plate 6 at the downstream side of the anaerobic treatment region 26 in the tank body 2, and flows into the transferring baffle 21.

Then, the sewage W passes through the transfer port 23 of the first partitioning plate 6 from the transferring baffle 21 to be transferred to the aerobic treatment region 43.

Then, the sewage W flows downward from upward in the aerobic treatment region 43 while being mixed and agitated, and passes through the filter filled layer 52 provided in the aerobic treatment region 43. Here, gas is diffused into the sewage W in the aerobic treatment region 43 by the gas diffuser 53, and the amount of dissolved oxygen in the sewage W is increased.

Then, when the sewage W passes through the filter filled layer 52, the organic matter and sludge in the sewage W are aerobically biodegraded by the aerobic microbes adhered to the aerobic filters of the filter filled layer 52.

Then, the sewage W after passage through the filter filled layer 52 flows into the precipitation region 44 from the flow-out port 42 at the lower end side of the second partitioning plate 41 of the tank body 2, and sludge such as foreign matter contained in the sewage W is precipitated and separated in the precipitation region 44 so that the sewage W forms into the treated water F.

Then, the treated water F flows upward from downward in the precipitation region 44, overflows the overflow baffle 62 in the precipitation region 44, and flows to be discharged outward from the flow-out port 64 of the tank body 2.

Further, the sludge deposited on the bottom 5 of the aerobic treatment region 43 and precipitation region 44 is, as the need arises, discharged outward through the sludge transfer pipe 56 of the returning unit 55, and returned into the flow-in baffle 11 in the straightening region 25.

Additionally, when the sludge and the like are adhered to the anaerobic filters filled into the filter filled layer 52 in the anaerobic treatment region 43, gas such as air is diffused from the part lower than the filter filled layer 52 by the backwash unit 54, the sewage W is made to flow upward from downward in the filter filled layer 52, the sludge adhered to the aerobic filters filled into the filter filled layer 52 is washed away, and the aerobic filters are washed.

As described above, according to the embodiment of the present invention, for example, the plurality of fiber filters 30, in which the ends of the fibrous materials 32 of the fiber bundle 31 formed by bundling the plurality of fibrous materials 32 made of carbon fibers are connected to each other at the fixation part 33, and the other ends of the fibrous materials 32 of the fiber bundle 31 are not connected and each is made as a free end, are used as filters of the anaerobic filter-bed tank 7 of the sewage purifier 1.

Thus, in subjecting the sewage W to the anaerobic treatment with use of the fiber filters 30, the surface area of the fiber filter 30 is greatly increased compared with a conventional ball-shaped or cylindrical filter, since a part, which is not fixed at the fixation part 33, of the plurality of fibrous materials 32 of the fiber filter 30 spread and develop in a tuft shape in the sewage W. Accordingly, the anaerobic treatment of the sewage W with use of the fiber filters 30 allows capacity necessary for treatment of the sewage W to be reduced and effectively used. Further, since the fiber filter 30 has a simple constitution that the ends of the bundled plurality of fibrous materials 32 are fixed to the fixation part 33, the fiber filters 30 can be easily manufactured.

Additionally, the straightening baffle 16 is attached in the straightening region 25 at the upstream side of the tank body 2, and the flow of the sewage W in the straightening region 25 is laterally straightened by the straightening baffle 16. As a result of this, the sewage W, the flow of which is laterally straightened by the straightening baffle 16, allows the part, which is not fixed at the fixation part 33, of the fibrous materials 32 of the fiber filter 30 attached in the anaerobic treatment region 26 to efficiently spread and develop in a tuft shape in the sewage W. Accordingly, the fibrous materials 32 of the fiber filters 30 can be efficiently brought into contact with the sewage W, and thus the fiber filters 30 allow the sewage W to be efficiently subjected to the anaerobic treatment.

Additionally, since the part, which is not fixed at the fixation part 33, of the fibrous materials 32 of the fiber filter 30 develops in a tuft shape in the sewage W, the flow of the sewage W in the anaerobic treatment region 26 can be evenly laterally straightened. Since the flow of the sewage W passing through the anaerobic treatment region 26 is thus laterally straightened by the straightening baffle 16 and the fiber filters 30, the sludge deposited on the bottom 5 of the anaerobic treatment region 26 can be hardly kicked up and hardly moved. Accordingly, a larger amount of the sludge, which forms into a clump after being held by the fibrous materials 32 of the fiber filter 30 and is peeled off, can be deposited on the bottom 5 in the anaerobic treatment region 26, the capacity of the anaerobic treatment region 26 is more efficiently used, and the sewage W can be stored. Thus, the capacity of the tank body 2 can be effectively used.

Additionally, large amounts of anaerobic microbes adhered to the fibrous materials 32 of each fiber filters 30 provided in the anaerobic treatment region 26 allows the sludge held by and deposited on the fibrous materials 32 of the fiber filters 30 to be anaerobically biodegraded, and thus the amount of the sludge peeled off after being held by the fibrous materials 32 of the fiber filters 30 can be reduced.

Further, since the sludge is peeled off from the fibrous materials 32 of the fiber filter 30 when the amount of the sludge held by the fibrous materials 32 of the fiber filter 30 reaches a certain degree, the fibrous materials 32 of the fiber filter 30 can be constantly developed in a tuft shape in the sewage W. Accordingly, the fibrous materials 32 of the fiber filters 30 can be efficiently brought into contact with the sewage W, and hardly any trouble arises such that the anaerobic filter-bed tank 7 is closed by growth of the sludge held by the fibrous materials 32 of the fiber filters 30.

Furthermore, the plurality of attachment members 34 are arranged zigzag in the plan view, and in the plane shape, and vertically attached in the anaerobic treatment region 26 in the tank body 2, and the fiber filters 30 are vertically aligned at even intervals and attached to each attachment member 34 with each fixation part 33 side of the fiber filter 30 directed upward. As a result of this, a greater number of fiber filters 30 can be efficiently provided in the anaerobic treatment region 26, and thus the efficiency of anaerobic treatment of the sewage W in the anaerobic treatment region 26 by the fiber filters 30 can be further raised.

As described above, since the anaerobic filter-bed tank 7 in the tank body 2 has a simple constitution in which the fiber filters 30 are arranged, the sludge can be drawn out from any position of the anaerobic filter-bed tank 7, and the tank body 2 can be easily manufactured due to the simple constitution of the anaerobic filter-bed tank 7. Additionally, since the fiber filters 30 allow the treatment efficiency of the anaerobic filter-bed tank 7 to be physically and biologically raised, the anaerobic filter-bed tank 7 can be effectively used.

Moreover, although the fiber filter 30 is formed so that the ends of the plurality of bundled fibrous materials 32 are connected to each other at the fixation part 33 in the above-mentioned embodiment, if it is constituted in a manner that any positions of the plurality of fibrous materials 32 are connected to each other at the fixation part 33, for example, any fiber filter 30 is applicable which is constituted in a manner that the middle parts of the bundled fibrous materials 32 in a longitudinal direction are connected to each other at the fixation part 33.

Additionally, although the fibrous material 32 of the fiber filter 30 is made of carbon filter, it may be made of other chemical fiber if a necessary surface area can be secured by the chemical filter.

Further, although the attachment members 34 are provided in the vertical direction of the anaerobic filter-bed tank 7 in the tank body 2 and the fiber filters 30 are attached to each attachment member 34 at even intervals, the attachment members 34 may be provided in the lateral direction of the anaerobic filter-bed tank 7 in a state of being separated from each other in the vertical and width directions of the tank body 2, and the fiber filters 30 may be attached to each attachment member 34.

Additionally, the sludge transfer pipe 56 provided in the contact aeration tank 51 may be provided in the precipitation tank 61.

What is claimed is:

1. A water treatment contact filter comprising:
a fiber bundle having a plurality of fibrous materials and in which the plurality of fibrous materials are bundled; and
a fixation part for fixing at least a part of the fiber bundles.

2. A water treatment apparatus comprising:
a treatment tank in which the water treatment contact filter according to claim 1 is arranged and water to be treated is stored; and
straightening means for horizontally straightening the flow of the water to be treated in the treatment tank.

3. The water treatment apparatus according to claim 2, comprising a plurality of water treatment contact filters wherein the plurality of water treatment contact filters are arranged zigzag in a plan view.

4. The water treatment apparatus according to claim 2, comprising a plurality of water treatment contact filters wherein the plurality of water treatment contact filters are vertically aligned.

5. The water treatment apparatus according to claim 3, comprising a plurality of water treatment contact filters wherein the plurality of water treatment contact filters are vertically aligned.
